(19) United States
(12) Patent Application Publication
(10) Pub. No.: US 2019/0059399 A1
(43) Pub. Date: Feb. 28, 2019

(54) Refrigerated patty press

(71) Applicant: Taylor Commercial Foodservice Inc., Rockton, IL (US)

(72) Inventors: Kelsey Meinert, Pecatonica, IL (US); Jeffrey L. Sands, Freeport, IL (US); Dennis J. Nelson, Rockford, IL (US)

(21) Appl. No.: 15/999,507

(22) Filed: Aug. 20, 2018

Related U.S. Application Data
(60) Provisional application No. 62/549,790, filed on Aug. 24, 2017.

(51) Int. Cl. A22C 7/00; A23P 30/10

(52) U.S. Cl. CPC A22C 7/0084; A22C 7/0046; A23P 30/10

(57) ABSTRACT

A method of operating a device for preparing a formed food product includes receiving at a controller an input indicating one or more parameters of the formed food product, molding a portion of a food composition into a shape corresponding to the desired form in response to receiving the input, and separating the molded food composition from a non-molded portion of the food composition in response to receiving the input to create the formed food product having a desired thickness.

### RELATED APPLICATION

The present patent document claims the benefit of the filing date under 35 U.S.C. § 119(e) of Provisional U.S. Patent Application Ser. No. 62/549,790, filed Aug. 24, 2017, which is hereby incorporated by reference.

### BACKGROUND

The subject matter disclosed herein relates to food preparation systems. More specifically, the subject disclosure relates to a system for forming or molding a food product into a desired shape.

Devices for molding food products into desired shapes are generally known. In a commercial or industrial setting, the mold devices are large units that may include multiple mold cavities. After a food product has been molded within the mold cavities, the molded food is typically packaged and/or frozen prior to being delivered to a consumer.

### BRIEF DESCRIPTION

According to one embodiment, a method of operating a device for preparing a formed food product includes receiving at a controller an input indicating one or more parameters of the formed food product, molding a portion of a food composition into a shape corresponding to the desired form in response to receiving the input, and separating the molded food composition from a non-molded portion of the food composition in response to receiving the input to create the formed food product having a desired thickness.

In addition to one or more of the features described above, or as an alternative, in further embodiments molding the portion of the food composition within a die further comprises extruding the food composition through a die.

In addition to one or more of the features described above, or as an alternative, in further embodiments extruding the food composition further comprises applying a force to the food composition via a press.

In addition to one or more of the features described above, or as an alternative, in further embodiments applying the force to the food composition further comprises translating the press relative to a container within which the food composition is located and the die.

In addition to one or more of the features described above, or as an alternative, in further embodiments comprising selecting one of a plurality of interchangeable dies associated with the formed food product.

In addition to one or more of the features described above, or as an alternative, in further embodiments the input indicating one or more parameters is provided from an ordering system in communication with the controller.

In addition to one or more of the features described above, or as an alternative, in further embodiments comprising moving the formed food product towards a downstream component of a food preparation system.

In addition to one or more of the features described above, or as an alternative, in further embodiments moving the formed food product towards a downstream component of a food preparation system occurs automatically via a movement mechanism extending between the device and the downstream component of a food preparation system.

In addition to one or more of the features described above, or as an alternative, in further embodiments the downstream component is one of a seasoning station and a cooking station.

In addition to one or more of the features described above, or as an alternative, in further embodiments the device receives the food composition from an upstream portion of a food preparation system.

In addition to one or more of the features described above, or as an alternative, in further embodiments the food composition is provided to the device manually.

According to another embodiment, a device for processing a food product into a predetermined form includes a chamber for storing a food composition. The device is operable in response to an input to form a portion of the stored food composition into the food product having a predetermined form.

In addition to one or more of the features described above, or as an alternative, in further embodiments the chamber is refrigerated.

In addition to one or more of the features described above, or as an alternative, in further embodiments the chamber is sized to receive a large format of food composition.

In addition to one or more of the features described above, or as an alternative, in further embodiments comprising a die positioned adjacent the chamber, the die having a shape corresponding to the predetermined form; a press for moving the food composition through the die; and a cutting mechanism positioned generally adjacent the die, wherein the cutting mechanism is movable to separate the shaped food composition output from the die from the food composition within the chamber.

In addition to one or more of the features described above, or as an alternative, in further embodiments the die is one of a plurality of interchangeable dies.

In addition to one or more of the features described above, or as an alternative, in further embodiments comprising a movement mechanism located downstream from the cutting device for receiving the food product having the predetermined form.

In addition to one or more of the features described above, or as an alternative, in further embodiments the food product having the predetermined form is provided to the movement mechanism via gravity.

In addition to one or more of the features described above, or as an alternative, in further embodiments the movement device transports the food product having the predetermined form to a downstream portion of a food preparation system.

In addition to one or more of the features described above, or as an alternative, in further embodiments chamber receives the food composition from an upstream portion of a food preparation system.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a cross-sectional view of a device for forming food product into a desired form according to an embodiment;

FIG. 2 is a perspective view of a device for forming food product into a desired form according to an embodiment; and

FIG. 3 is a perspective view of another device for forming food product into a desired form according to an embodiment;

FIG. 4 is a flow diagram of a food preparation system according to an embodiment; and

FIG. 5 is a schematic diagram of a control system of the device according to an embodiment.

The detailed description explains embodiments of the disclosure, together with advantages and features, by way of example with reference to the drawings.

### DETAILED DESCRIPTION

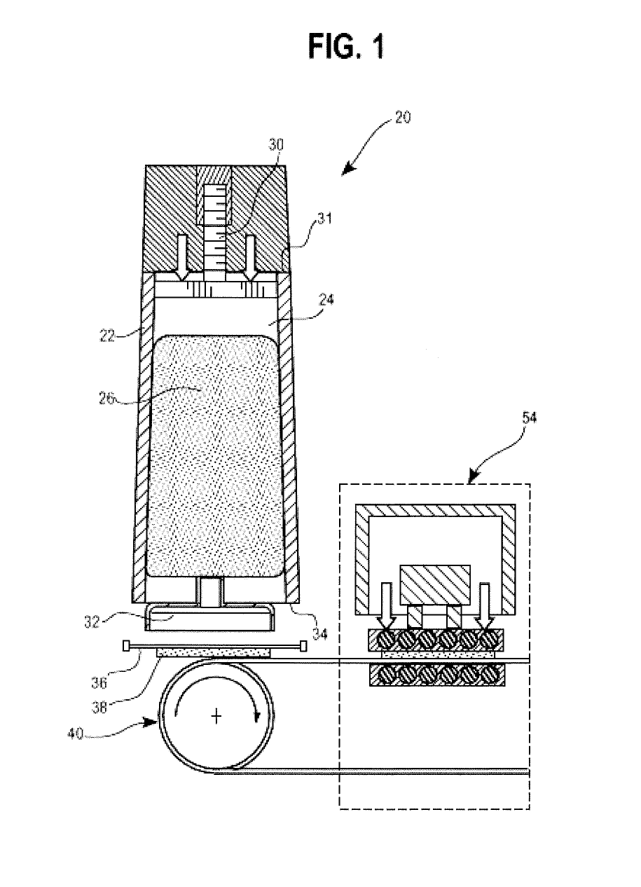

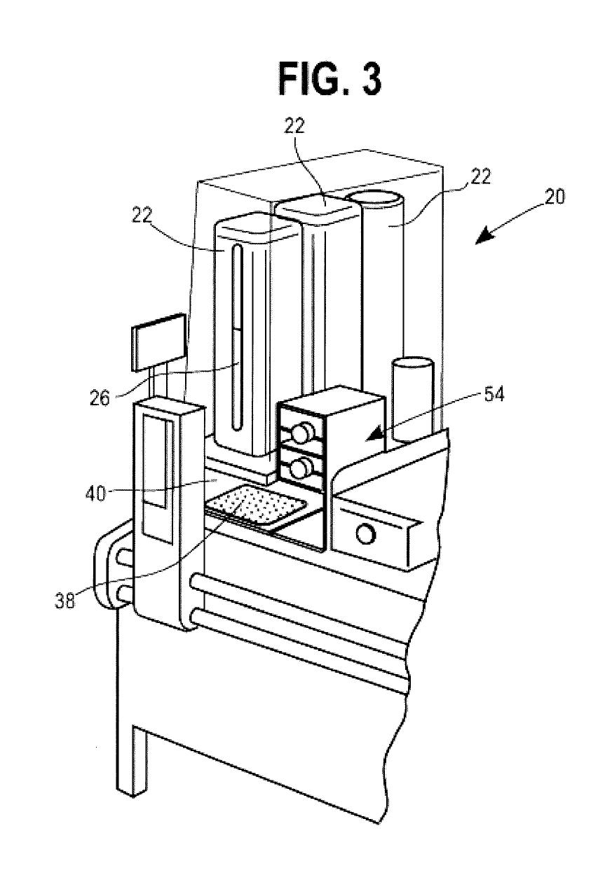

Referring now to the FIGS., an example of a device or apparatus 20 for processing a food product into a predetermined form is illustrated. In its simplest form, as shown in FIG. 1, the device 20 includes a container 22 having a hollow internal cavity or chamber 24. In other embodiments, the device 20 may include a plurality of interconnected or distinct chambers 24. In embodiments where the plurality of chambers 24 are distinct, the device 20 may include a single container 22 having multiple chambers 24, or alternatively, may include multiple containers 22, as shown in FIG. 3. Further, although the container 22 is illustrated in a vertically oriented configuration, embodiments where the container 22 is arranged in another orientation, such as horizontally, or at an angle for example, are also contemplated herein.

A food product 26, for example a ground material such as beef, is positionable within an internal chamber 24 of the container 22. The food product 26 may include a single ingredient or may be a prepared mixture or composition. The container 22 may be sized to receive any suitable quantity of food product 26. In commercial applications, the container 22 may be sized to receive a loaf or bag of food product 26 suitable to form a plurality of individual servings or patties having a predetermined form. For example, the container 22 may be sized to receive an amount of food product 26 expected to be used within several days, within one day, or within a portion of a day.

The container 22 and/or the internal chamber 24 is refrigerated to maintain the freshness of the food product 26 located therein for a period of time. In an embodiment, the freshness of the food product 26 within the chamber 24 may be maintained for a period of time exceeding the length of time required to use the food product 26 within the chamber 24. To refrigerate the container 22, one or more fluid channels (not shown) may be formed in the container 22 through which a refrigerant or other cooling fluid passes. Alternatively, the container 22 may be located within a refrigerated area. It should be understood that any suitable mechanism or means for refrigerating at least the internal chamber 24 of the container 22 to maintain the integrity of the food product 26 located therein is contemplated herein.

The device 20 additionally includes at least one press or plunger 30 configured to cooperate with the container 22 to expel all or a portion of the food product 26 therefrom. In embodiments where the device 20 includes a plurality of chambers 24, at least one press 30 is associated with each chamber 24. When the entire internal chamber 24 is filled with food product 26, as shown in FIG. 1, the at least one press 30 is located generally adjacent a first, input end 31 of the internal chamber 24. In an embodiment, the press 30 has a cross-sectional area generally equal to or slightly smaller than a cross-sectional the area of the internal chamber 24 of the container 22. In embodiments where multiple presses 30 are associated with the same internal chamber 24, each press 30 has a cross-sectional shape smaller than and complementary to at least a portion of the internal chamber 24. Each press 30 is movable through the internal chamber 24, for example along a longitudinal axis X of the container 22.

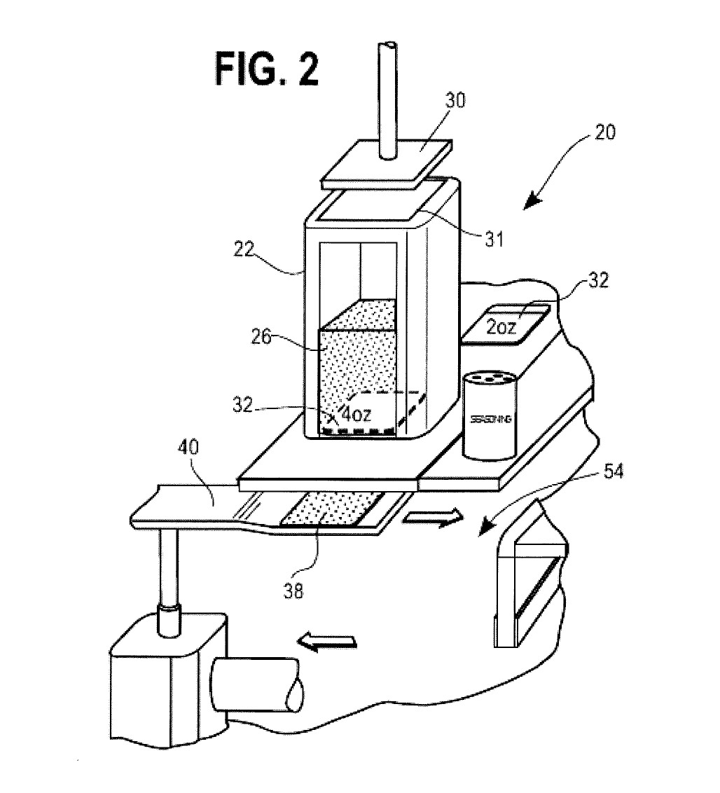

One or more dies 32 having a cross-sectional shape corresponding to the desired shape of the food product to be formed is positionable adjacent a second, output end 34 of the container 22, in communication with the at least one internal chamber 24. The food product formed by the device 20 is generally referred to herein as a “patty”; however a formed food product having any configuration is within the scope of the disclosure. In embodiments where multiple dies 32 are associated with the same internal chamber 24, the plurality of dies 32 having different configurations may be interchangeably coupled to the container 22. For example, with reference to FIG. 2, a first die 32 may be associated with forming a patty containing two ounces of food product 26 and a second die 32 may be associated with forming a patty containing four ounces of food product 26. Alternatively, more than one die 32 may be disposed in communication with the internal chamber 24 at a time. In such embodiments, the multiple dies 32 are at least horizontally offset, and in some instances vertically offset, from one another. If a die 32 is positioned adjacent the output end 34 of the internal chamber 24, the food product 26 is expelled in a desired shape complementary to the die 32.

Located downstream from the one or more dies 32 of the device 20 is at least one cutting device 36. The cutting device 36 may be associated with a single die 32, or with a plurality of dies 32. In the illustrated, non-limiting embodiment, the cutting device 36 has a sharp edge suitable to pierce the food product 26. Although the cutting device 36 is illustrated as a knife or slicer, any suitable mechanism is contemplated herein. The cutting device 36 is movable relative to the die 32, such as within a plane for example. Operation of the cutting device 36 is configured to separate all or a portion of the food product 26 protruding from the die 32 from the food product 26 within the internal chamber 24 to form a patty 38 having a desired shape.

In operation, a patty 38 having a desired shape is formed by moving the press 30 into contact with an adjacent end of the food product 26 to apply a force thereto. The movement of the press 30 reduces the volume of the internal chamber 24, causing the food product 26 to translate within the internal chamber 24. As the food product 26 moves within the chamber 24, a portion of the food product 26 is forced through the die 32, where the portion of food product 26 is molded into a desired shape. In an embodiment, the movement of the press 30 is controlled so that a limited amount of food product 26 equal to a patty 38 having a desired thickness, is extruded through from the die 32. The cutting device 36 separates the extruded food product 26 from the remainder of the food product 26, thereby forming a patty 38 having a desired shape and size.

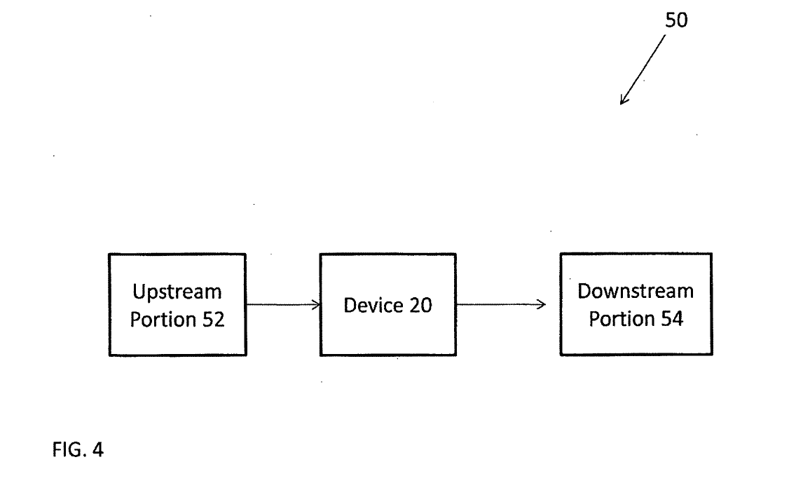

In an embodiment, the device 20 for processing a food product into a predetermined form is part of a larger food preparation system 50. With reference to FIG. 4, in an embodiment, the food product 26 may be provided to the internal chamber 24 from another device within the system 50, such as a mixer or grinder illustrated schematically at 52 for example, disposed upstream from the device 20. Alternatively, the food product may be inserted into the internal chamber manually.

Upon separation of the individual patty 38 from the remainder of the food product 26, the patty is provided to a movement mechanism 40 (see FIGS. 1 and 3). In an embodiment, the patty 38 is configured to fall, via gravity, onto the movement mechanism 40. The movement mechanism 40 illustrated in the FIGS. includes a conveyor or a spatula, however, any suitable mechanism for transporting the formed patty 38 is within the scope of the disclosure. The movement mechanism 40 is configured to deliver the formed patty to a downstream portion of the food preparation system 50, illustrated schematically at 54, such as a cooking station or a seasoning station for example. In some embodiments, automatic seasoning of the patty 38 may occur prior to or at the time the patty 38 formed. The downstream portion 54 of the food preparation system 50 may be arranged in line with the device 20, and the movement mechanism 40 may be configured to automatically transport the formed patty 38 to the downstream portion 54 of the food preparation system 50.

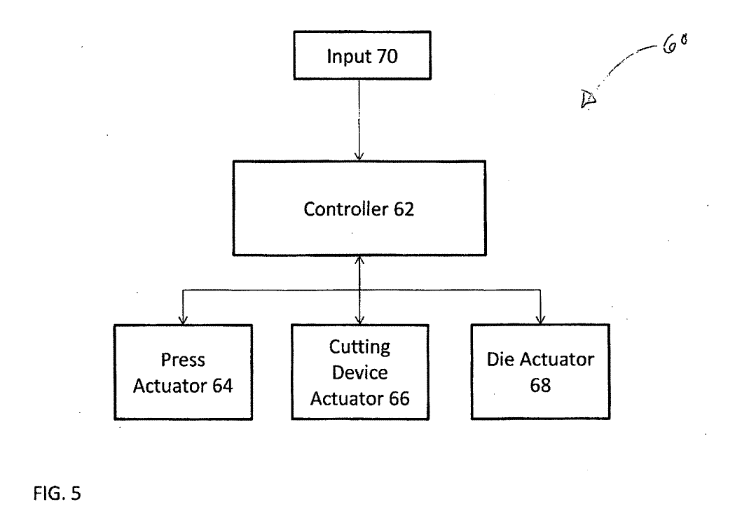

A control system 60 of the device 20 is illustrated in FIG. 5. As shown, the control system 60 generally includes a controller 62 configured to communicate with various portions of the device 20. In an embodiment, the controller 62 is operably coupled to a press actuator 64 for moving the at least one press 30 relative to the container 22. The controller 62 may generate a command indicating how far and in what direction to move the press 30 to create a patty 38 having a desired thickness. Similarly, the controller 62 communicates with an actuator 66 responsible for moving the cutting device 36 relative to separate the patty 38 from the food product 26. In embodiments where multiple dies 32 are removably coupled to the container 22, the controller 62 is operably coupled to an actuator 68 for positioning the dies 32. Accordingly, the controller 62 provides a signal to the actuator 68 indicating which die 32 to move into alignment with the internal chamber 24. In an embodiment, each of the actuators, or alternatively, a corresponding position sensor (not shown) may be arranged to provide feedback to the controller 62 indicating a current state and/or position of the press 30, cutting mechanism 36, and plurality of dies 32.

The commands output from the controller 62 to the plurality of actuators 64, 66, 68 are generated in response to the desired shape and size of a patty 38 to be formed. One or more settings of the device 20 may be set to control the shape and size of the patty 38 to be formed. In an embodiment, the device 20 is configured to process the food product 26 into a desired form “on-demand.” In such embodiments, an input signal 70 is provided to the controller 62 indicating the parameters of the patty 38 to be formed. The controller 62 will then adjust the die 32, and operate the press 30 and the cutting mechanism 36 accordingly to create a patty 38 corresponding to the input 70. The input 70 may be provided to the controller 62 of the device 20, for example, upon receipt of an order for a food item associated with the food preparation system 50. Accordingly, the patty 38 may be formed in real time, thereby maximizing the freshness and enhancing the taste of a product output from the food preparation system. Further, any amount of time may elapse between the formation of patties 38.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A method of operating a device for preparing a formed food product comprising:
receiving at a controller an input indicating one or more parameters of the formed food product;
molding a portion of a food composition into a shape corresponding to the desired form in response to receiving the input; and
separating the molded food composition from a non-molded portion of the food composition in response to receiving the input to create the formed food product having a desired thickness.

2. The method of claim 1, wherein molding the portion of the food composition within a die further comprises extruding the food composition through a die.

3. The method of claim 2, wherein extruding the food composition further comprises applying a force to the food composition via a press.

4. The method of claim 2, wherein applying the force to the food composition further comprises translating the press relative to a container within which the food composition is located and the die.

5. The method of claim 2, further comprising selecting one of a plurality of interchangeable dies associated with the formed food product.

6. The method of claim 1, wherein the input indicating one or more parameters is provided from an ordering system in communication with the controller.

7. The method of claim 1, further comprising moving the formed food product towards a downstream component of a food preparation system.

8. The method of claim 7, wherein moving the formed food product towards a downstream component of a food preparation system occurs automatically via a movement mechanism extending between the device and the downstream component of a food preparation system.

9. The method of claim 7, wherein the downstream component is one of a seasoning station and a cooking station.

10. The method of claim 1, wherein the device receives the food composition from an upstream portion of a food preparation system.

11. The method of claim 1, wherein the food composition is provided to the device manually.

12. A device for processing a food product into a predetermined form comprising:
a chamber for storing a food composition;
wherein the device is operable in response to an input to form a portion of the stored food composition into the food product having a predetermined form.

13. The device of claim 12, wherein the chamber is refrigerated.

14. The device of claim 12, wherein the chamber is sized to receive a large format of food composition.

15. The device of claim 12, further comprising:
a die positioned adjacent the chamber, the die having a shape corresponding to the predetermined form;
a press for moving the food composition through the die; and
a cutting mechanism positioned generally adjacent the die, wherein the cutting mechanism is movable to separate the shaped food composition output from the die from the food composition within the chamber.

16. The device of claim 14, wherein the die is one of a plurality of interchangeable dies.

17. The device of claim 14, further comprising a movement mechanism located downstream from the cutting device for receiving the food product having the predetermined form.

18. The device of claim 17, wherein the food product having the predetermined form is provided to the movement mechanism via gravity.

19. The device of claim 17, wherein the movement device transports the food product having the predetermined form to a downstream portion of a food preparation system.

20. The device of claim 12, wherein chamber receives the food composition from an upstream portion of a food preparation system.
